(19) United States
(12) Patent Application Publication
(10) Pub. No.: US 2025/0026106 A1
(43) Pub. Date: Jan. 23, 2025

(54) BIAXIALLY ORIENTED POLYOLEFIN FILMS

(71) Applicant: Dow Global Technologies LLC, Midland, MI (US)

(72) Inventors: Zhe Du, Shanghai (CN); Jianping Pan, shanghai (CN); Xiaobing Yun, Shanghai (CN); Shijun Wang, Shanghai (CN); Jingyi Xu, Shanghai (CN); Hong Yang, shanghai (CN)

(73) Assignee: Dow Global Technologies LLC, Midland, MI (US)

(21) Appl. No.: 18/712,002

(22) PCT Filed: Nov. 25, 2021
(86) PCT No.: PCT/CN2021/133162

§ 371 Date: May 21, 2024

(51) Int. Cl. B32B 7/022; B29C 55/14; B29K 23/00; B29K 105/00; B32B 27/08; B32B 27/32

(52) U.S. Cl. CPC B32B 7/022; B29C 55/143; B32B 27/08; B32B 27/32; B29K 2023/06; B29K 2023/12; B29K 2105/0094; B29K 2995/0053; B29K 2995/0063; B29K 2995/0088; B32B 2250/242; B32B 2307/518; B32B 2307/72

(57) ABSTRACT

A biaxially oriented multilayer film having a core layer that includes a polyethylene-based composition. The core layer has: a melt index (I₂) that is from 0.2 g/10 min to 5.0 g/10 min; a density that is between 0.930 g/cm³ and 0.956 g/cm³; and an average short chain branch (SCB) level in the portion between log (Mw) of 4.0 to 5.0 (SCB_{logMw4-5}) that is greater than 3.5 SCB/1000c and less than 10.0 SCB/1000 C. The biaxially oriented multilayer film also includes at least one additional layer that includes a propylene-based composition.

### FIELD

The present invention relates to biaxially oriented, multilayer polyolefin films comprising a polyethylene core, to laminates comprising such films, and to articles comprising such films and laminates.

### INTRODUCTION

Biaxially oriented polyethylene (BOPE) films have drawn significant attention in the flexible packaging market because they are very good candidates to replace oriented polyester film or oriented polyamide film in the development of sustainable and recyclable packaging. Although various polyethylene resins have been developed and commercialized for BOPE films, many of them have a density less than 0.930 g/cm³. Stiffness and heat resistance of the BOPE films made from such resins are significantly lower than oriented polyester film or oriented polyamide film. This has constrained the application of current BOPE films in the flexible packaging industry. Given the multilayer nature of flexible packaging and compatibility between certain polyolefins, including a small amount of foreign polyolefin can be acceptable in recycle system. For example, a polyethylene (PE)-based film containing a small amount of propylene-based polymer can still be recognized as a mono-PE package. That opens an opportunity to develop a PE-rich biaxially oriented polyolefin film with improved stiffness, heat resistance and balanced optical properties, and which can fulfill the market need for a more sustainable solution in the packaging industry.

One relatively new material technology on the processing side is biaxially oriented polyethylene (BOPE) films formed by cast extrusion, and then oriented in the machine direction (MD) followed by orientation in the transverse direction (TD) using a tenter frame. Alternatively, such orientation steps can also be performed simultaneously. Due to the molecular architecture, microstructure and crystallization kinetics of polyethylene, it is often difficult to biaxially orient conventional polyethylenes.

It would be desirable to have new polyethylene-based compositions that have good processability into BOPE films as well as new biaxially oriented polyethylene films having desired and/or improved properties.

### SUMMARY

Typically, stiffness and heat resistance of PE films are controlled by the density of the PE. Films made of higher density PE generally have higher stiffness. However, increasing the density of PE may decrease the orientation stability and narrow the operating window significantly in the biaxial orientation process. Consequently, it has been difficult to make commercially acceptable BOPE films from higher density PE.

The present disclosure provides polyethylene-based compositions suitable for processing into biaxially oriented, multilayer polyethylene polyolefin films, as well as biaxially oriented, multilayer polyolefin films having desired and/or improved properties. Such polyethylene-based compositions, in some embodiments, can advantageously expand the operating window for stretching films to provide biaxially oriented polyolefin films. For example, by expanding the operating window for biaxial orientation, higher density polyethylenes can be oriented which can lead to improved film stiffness. Other advantages can include, without limitation, better conversion and printability of films, improved optics (e.g., higher clarity and lower haze); improved barrier performance for metallized biaxially oriented polyethylene films, and improved processability on larger, wider tenter frames.

Aspect 1 includes a biaxially oriented multilayer film comprising: a core layer comprising a polyethylene-based composition, the core layer having: an overall melt index (I₂) that is from 0.2 g/10 min to 5.0 g/10 min; an overall density that is between 0.930 g/cm³ and 0.956 g/cm³; andan average short chain branch level in a portion between log (Mw) of 4.0 to 5.0 (SCB_{logMw4-5}) that is greater than 3.5 SCB/1000 C and less than 10.0 SCB/1000 C; andat least one additional layer, the at least one additional layer comprising a propylene-based composition.

Aspect 2 comprises the biaxially oriented multilayer film of aspect 1, wherein the propylene-based composition is selected from the group consisting of: a co-polymer of propylene and other olefins; a ter-polymer of propylene and other olefins; andcombinations thereof.

Aspect 3 comprises the biaxially oriented multilayer film of any one of aspects 1 or 2, wherein the propylene-based composition has a DSC melt point that is from 120° C. to 150° C.

Aspect 4 comprises the biaxially oriented multilayer film any one of aspects 1 to 3, wherein the polyethylene-based composition is a blend comprising a first polyethylene-based component and a second polyethylene-based component.

Aspect 5 comprises the biaxially oriented multilayer film of aspect 4, whereinthe first polyethylene-based component is a high density polyethylene (HDPE) having a melt index (I₂) that is from 01.0 g/10 min to 1.5 g/10 min, and a density that is from 0.965 g/cm³ to 0.970 g/cm³, the second polyethylene-based component is a linear low density polyethylene (LLDPE) having a melt index (I₂) that is from 0.1 g/10 min to 3.0 g/10 min, and a density that is from 0.915 g/cm³ to 0.930 g/cm³.

Aspect 6 comprises the biaxially oriented multilayer film of any one of aspects 4 or 5, wherein, the polyethylene-based composition further comprises a third polyethylene-based component.

Aspect 7 comprises the biaxially oriented multilayer film of aspect 6, wherein the third polyethylene-based component is a high density polyethylene (HDPE) that has a melt index (I₂) that is from 0.1 g/10 min to 0.5 g/10 min, and a density that is from 0.955 g/cm³ to 0.965 g/cm³.

Aspect 8 comprises the biaxially oriented multilayer film of any one of aspects 1 to 7, wherein the overall density of the core layer is from 0.940 g/cm³ to 0.955 g/cm³.

Aspect 9 comprises the biaxially oriented multilayer film of any one of aspects 1 to 8, wherein the core layer has an average SCBlogMw4-5 that is greater than 4.5 SCB/1000 C.

Aspect 10 comprises the biaxially oriented multilayer film of any one of aspects 1 to 9, wherein the biaxially oriented multilayer film was oriented in the machine direction at a draw ratio that is from 4:1 to 7:1; andoriented in the transverse direction at a draw ratio from 6:1 to 12:1.

Aspect 11 comprises the biaxially oriented multilayer film of any one of aspects 1 to 10, wherein the core layer comprises greater than 70% of an overall thickness of the biaxially oriented multilayer film.

Aspect 12 comprises the biaxially oriented multilayer film of any one of aspects 1 to 11, wherein the core layer comprises greater than 90% of an overall thickness of the biaxially oriented multilayer film.

Aspect 13 comprises the biaxially oriented multilayer film of any one of aspects 1 to 12, wherein the biaxially oriented multilayer film has a machine direction modulus that is from 500 MPa to 3500 MPa, and a transverse direction modulus that is from 700 MPa to 4000 MPa.

Aspect 14includesan article comprising the biaxially oriented multilayer film of any one of aspects 1 to 13, wherein the article is a flexible package, a pouch, a stand-up pouch, a pre-made package, or a pre-made pouch.

Aspect 15 includes a laminated product comprising the biaxially oriented multilayer film of any one of aspects 1 to 13.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials, which comprises the composition, as well as reaction products and decomposition products formed from the materials of the composition.

“Polymer” means a polymeric compound prepared by polymerizing monomers, whether of the same or a different type. The generic term polymer thus embraces the term homopolymer as defined hereafter, and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “homopolymer,” as used herein, refers to polymers prepared from only one type of monomer with the understanding that trace amounts of impurities can be incorporated into the polymer structure.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (α) position.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono-or bis-cyclopentadienyl catalysts (typically referred to as metallocene), constrained geometry catalysts, phosphinimine catalysts & in polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono-or bis-cyclopentadienyl catalysts (typically referred to as metallocene), constrained geometry catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono-or bis-cyclopentadienyl catalysts (typically referred to as metallocene), constrained geometry catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono-or bis-cyclopentadienyl catalysts (typically referred to as metallocene), constrained geometry catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers and plastomers generally have densities of 0.855 to 0.912 g/cm³.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The present disclosure generally relates to biaxially oriented, multilayer polyolefin films having a polyethylene core. Such films are biaxially oriented using a tenter frame in some embodiments. The biaxially oriented, multilayer polyethylene films utilize a core layer comprising a polyethylene-based composition. For example, by expanding the operating window for biaxial orientation, higher density polyethylenes can be oriented which can lead to improved film stiffness. The biaxially oriented, multilayer polyethylene films, in some embodiments, can be used in packaging applications.

In embodiments, a biaxially oriented, multilayer polyethylene film comprises a core layer comprising: a polyethylene-based composition that comprises: a melt index (I₂) from 0.2 grams per ten minutes (g/10 min) to 5.0 g/10 min; a density that is from 0.930 grams per cubic centimeter (g/cm³) to 0.956 g/cm³; and an average short chain branch (SCB) level in the portion having a log of weight average molecular weight from 4.0 to 5.0 (SCB_{logMw4-5}) that is greater than 3.5 SCB/1000 C.

In some embodiments, the polyethylene core of the biaxially oriented multilayer film comprise at least 70% of the film thickness. In one or more embodiments, the biaxially oriented multilayer film comprises at least one skin layer and the at least one skin layer comprises a propylene-based polymer with a differential scanning calorimetry (DSC) melting point that is from 120° C. to 150° C.

In some embodiments, a biaxially oriented multilayer film, according to any of the embodiments described herein, has been oriented in the machine direction at a draw ratio that is from 4:1 to 7:1 and in the transverse direction at a draw ratio from 6:1 to 12:1. The biaxially oriented film, in some embodiments, has been oriented in the machine direction at a draw ratio from 5:1 to 6:1 and in the transverse direction at a draw ratio from 8:1 to 10:1.

In embodiments, the polyethylene-based composition comprises a blend of a first polyethylene-based component and a second polyethylene-based component. In embodiments, the first polyethylene-based component is an HDPE having properties as further described herein and the second polyethylene-based component may be a LLDPE having properties as further described herein. In one or more embodiments, the polyethylene-based composition comprises a third polyethylene-based component. In embodiments, the third polyethylene-based component may be an HDPE as described further herein.

In embodiments, biaxially oriented polyethylene multilayer film disclosed herein may be used in packaging, such as food packaging. In embodiments, an article comprises any of the biaxially oriented multilayer films disclosed herein.

### Core Layer

As discussed above, the biaxially oriented multilayer films disclosed herein include a core layer comprising at least a polyethylene-based composition and having certain properties. In embodiments, the core layer has a melt index (I₂) that is from 0.2 g/10 min to 5.0 g/10 min; a density that is from 0.930 g/cm³ to 0.956 g/cm³; and an average SCB level in the portion between log (Mw) of 4.0 to 5.0 (SCB_{logMw4-5}) that is greater than 3.5 SCB/1000 C.

In embodiments, the core layer has a melt index (I₂) that is from 0.5 g/10 min to 5.0 g/10 min, such as from 1.0 g/10 min to 5.0 g/10 min, from 1.5 g/10 min to 5.0 g/10 min, from 2.0 g/10 min to 5.0 g/10 min, from 2.5 g/10 min to 5.0 g/10 min, from 3.0 g/10 min to 5.0 g/10 min, from 3.5 g/10 min to 5.0 g/10 min, from 4.0 g/10 min to 5.0 g/10 min, from 4.5 g/10 min to 5.0 g/10 min, from 0.2 g/10 min to 4.5 g/10 min, from 0.5 g/10 min to 4.5 g/10 min, from 1.0 g/10 min to 4.5 g/10 min, from 1.5 g/10 min to 4.5 g/10 min, from 2.0 g/10 min to 4.5 g/10 min, from 2.5 g/10 min to 4.5 g/10 min, from 3.0 g/10 min to 4.5 g/10 min, from 3.5 g/10 min to 4.5 g/10 min, from 4.0 g/10 min to 4.5 g/10 min, from 0.2 g/10 min to 4.0 g/10 min, from 0.5 g/10 min to 4.0 g/10 min, from 1.0 g/10 min to 4.0 g/10 min, from 1.5 g/10 min to 4.0 g/10 min, from 2.0 g/10 min to 4.0 g/10 min, from 2.5 g/10 min to 4.0 g/10 min, from 3.0 g/10 min to 4.0 g/10 min, from 3.5 g/10 min to 4.0 g/10 min, from 0.2 g/10 min to 3.5 g/10 min, from 0.5 g/10 min to 3.5 g/10 min, from 1.0 g/10 min to 3.5 g/10 min, from 1.5 g/10 min to 3.5 g/10 min, from 2.0 g/10 min to 3.5 g/10 min, from 2.5 g/10 min to 3.5 g/10 min, from 3.0 g/10 min to 3.5 g/10 min, from 0.2 g/10 min to 3.0 g/10 min, from 0.5 g/10 min to 3.0 g/10 min, from 1.0 g/10 min to 3.0 g/10 min, from 1.5 g/10 min to 3.0 g/10 min, from 2.0 g/10 min to 3.0 g/10 min, from 2.5 g/10 min to 3.0 g/10 min, from 0.2 g/10 min to 2.5 g/10 min, from 0.5 g/10 min to 2.5 g/10 min, from 1.0 g/10 min to 2.5 g/10 min, from 1.5 g/10 min to 2.5 g/10 min, from 2.0 g/10 min to 2.5 g/10 min, from 0.2 g/10 min to 2.0 g/10 min, from 0.5 g/10 min to 2.0 g/10 min, from 1.0 g/10 min to 2.0 g/10 min, from 1.5 g/10 min to 2.0 g/10 min, from 0.2 g/10 min to 1.5 g/10 min, from 0.5 g/10 min to 1.5 g/10 min, from 1.0 g/10 min to 1.5 g/10 min, from 0.2 g/10 min to 1.0 g/10 min, from 0.5 g/10 min to 1.0 g/10 min, or from 0.2 g/10 min to 0.5 g/10 min.

In one or more embodiments, the core layer has a density that is from 0.935 g/cm³ to 0.956 g/cm³, such as from 0.938 g/cm³ to 0.956 g/cm³, from 0.940 g/cm³ to 0.956 g/cm³, from 0.942 g/cm³ to 0.956 g/cm³, from 0.945 g/cm³ to 0.956 g/cm³, from 0.948 g/cm³ to 0.956 g/cm³, from 0.950 g/cm³ to 0.956 g/cm³, from 0.952 g/cm³ to 0.956 g/cm³, from 0.935 g/cm³ to 0.952 g/cm³, from 0.938 g/cm³ to 0.952 g/cm³, from 0.940 g/cm³ to 0.952 g/cm³, from 0.942 g/cm³ to 0.952 g/cm³, from 0.945 g/cm³ to 0.952 g/cm³, from 0.948 g/cm³ to 0.952 g/cm³, from 0.950 g/cm³ to 0.952 g/cm³, from 0.935 g/cm³ to 0.950 g/cm³, from 0.938 g/cm³ to 0.950 g/cm³, from 0.940 g/cm³ to 0.950 g/cm³, from 0.942 g/cm³ to 0.950 g/cm³, from 0.945 g/cm³ to 0.950 g/cm³, from 0.948 g/cm³ to 0.950 g/cm³, from 0.935 g/cm³ to 0.948 g/cm³, from 0.938 g/cm³ to 0.948 g/cm³, from 0.940 g/cm³ to 0.948 g/cm³, from 0.942 g/cm³ to 0.948 g/cm³, from 0.945 g/cm³ to 0.948 g/cm³, from 0.935 g/cm³ to 0.945 g/cm³, from 0.938 g/cm³ to 0.945 g/cm³, from 0.940 g/cm³ to 0.945 g/cm³, from 0.942 g/cm³ to 0.945 g/cm³, from 0.935 g/cm³ to 0.942 g/cm³, from 0.938 g/cm³ to 0.942 g/cm³, from 0.940 g/cm³ to 0.942 g/cm³, from 0.935 g/cm³ to 0.940 g/cm³, from 0.938 g/cm³ to 0.940 g/cm³, or from 0.935 g/cm³ to 0.938 g/cm^{3.}

In one or more embodiments, the core layer has an average SCB level in the portion between log (Mw) of 4.0 to 5.0 (SCB_{logMw4-5}) is greater than 3.5 SCB/1000 C, such as greater than 4.0 SCB/1000 C, greater than 4.5 SCB/1000 C, greater than 5.0 SCB/1000 C, greater than 5.5 SCB/1000 C, greater than 6.0 SCB/1000 C, greater than 6.5 SCB/1000 C, or greater than 7.0 SCB/1000 C. In one or more embodiments, the maximum average SCB level in the portion between log (Mw) of 4.0 to 5.0 (SCB_{logMw4-5}) is 10.0 SCB/1000 C and can be applied to any of the above values. SCB_{logMw4-5} is measured according to the test procedures described herein below.

In one or more embodiments, the core layer has a DSC melt point (Tₘ) that is from 125.0° C. to 135.0° C., such as from 128.0° C. to 135.0° C., from 130.0° C. to 135.0° C., from 132.0° C. to 135.0° C., from 125.0° C. to 132.0° C., from 128.0° C. to 132.0° C., from 130.0° C. to 132.0° C., from 125.0° C. to 130.0° C., from 128.0° C. to 130.0° C., or from 125.0° C. to 128.0° C.

In some embodiments, the polyethylene-based composition in the core layer comprises a blend of two or more polyethylene-based components. It should be understood that where the polyethylene-based composition is a blend, the blend may be achieved by any of in-reactor blending, melt blending, dry blending, or a combination of these blending methods.

In embodiments where the polyethylene-based composition in the core layer comprises a blend of two or more polyethylene-based components, the core layer comprises a first polyethylene-based component. The first polyethylene-based component, in embodiments, is a high density polyethylene having a melt index (I₂) that is from 0.1 g/10 min to 2.5 g/10 min, such as from 0.1 g/10 min to 1.0 g/10 min, from 0.1 g/10 min to 0.5 g/10 min, from 0.5 g/10 min to 2.5 g/10 min, from 0.5 g/10 min to 1.0 g/10 min, from 1.0 g/10 min to 1.5 g/10 min, or from 1.5 g/10 min to 2.5 g/10 min. In embodiments, the first polyethylene-based component has a density that is from 0.955 g/cm³ to 0.970 g/cm³, from 0.955 g/cm³ to 0.960 g/cm³, from 0.960 g/cm³ to 0.965 g/cm³, or from 0.965 g/cm³ to 0.970 g/cm³.

In one or more embodiments, the core layer of a biaxially oriented multilayer film comprises a polyethylene-based composition that is a blend of the first polyethylene-based component and a second polyethylene-based component. The second polyethylene-based component, in embodiments, is a LLDPE having a melt index (I₂) that is at least 0.1 g/10 min greater than the melt index (I₂) of the first polyethylene-based component, such as at least 0.3 g/10 min greater than the melt index (I₂) of the first polyethylene-based component, at least 0.5 g/10 min greater than the melt index (I₂) of the first polyethylene-based component, or at least 0.7 g/10 min greater than the melt index (I₂) of the first polyethylene-based component. In embodiments, the melt index (I₂) of the second polyethylene-based component is less than or equal to 10 g/10 min. Accordingly, in embodiments, the second polyethylene-based component has a melt index (I₂) that is from 0.2 g/10 min to 2.8 g/10 min, such as from 0.2 g/10 min to 1.3 g/10 min, from 0.2 g/10 min to 0.8 g/10 min, from 0.6 g/10 min to 2.8 g/10 min, from 0.6 g/10 min to 1.3 g/10 min, from 1.1 g/10 min to 1.8 g/10 min, or from 1.6 g/10 min to 2.8 g/10 min. In embodiments, the second polyethylene-based component has a melt index (I₂) that is from 0.2 g/10 min to 10.0 g/10 min, such as from 2.0 g/10 min to 8.0 g/10 min, or from 4.0 g/10 min to 6.0 g/10 min. In embodiments, the second polyethylene-based component has a density that is at least 0.005 g/cm³ less than the density of the first polyethylene-based component, such as at least 0.01 g/cm³ less than the density of the first polyethylene-based component, at least 0.02 g/cm³ less than the density of the first polyethylene-based component, at least 0.03 g/cm³ less than the density of the first polyethylene-based component, at least 0.04 g/cm³ less than the density of the first polyethylene-based component, at least 0.05 g/cm³ less than the density of the first polyethylene-based component, or at least 0.06 g/cm³ less than the density of the first polyethylene-based component. In embodiments, the density of the second polyethylene-based component is greater than 0.900 g/cm³. In embodiments, the second polyethylene-based component has a density that is from 0.900 g/cm³ to 0.950 g/cm³, from 0.910 g/cm³ to 0.948 g/cm³, or from 0.920 g/cm³ to 0.945 g/cm³. In some embodiments, the second polyethylene-based component can be INNATE™ TF 80 commercially available from The Dow Chemical Company.

In one or more embodiments, the core layer of a biaxially oriented multilayer film comprises a polyethylene-based composition is a blend comprising at least the second polyethylene-based component and a third polyethylene-based component. The third polyethylene-based component, in embodiments, is a HDPE having a melt index (I₂) that is from 0.1 g/10 min to 0.5 g/10 min, such as from 0.3 g/10 min to 0.5 g/10 min, or from 0.1 g/10 min to 0.3 g/10 min. In embodiments, the third polyethylene-based component has a density that is from 0.955 g/cm³ to 0.965 g/cm³, from 0.960 g/cm³ to 0.965 g/cm³, or from 0.955 g/cm³ to 0.960 g/cm³. In embodiments, the third polyethylene-based component can be CONTINUUM™ DMDE-6620 available from The Dow Chemical Company.

In embodiments where the polyethylene-based composition comprises a blend of the first polyethylene-based component and the second polyethylene-based component, the polyethylene-based composition comprises the first polyethylene-based component in amounts from 15 wt % to 85 wt % of polyethylene-based composition, such as from 20 wt % to 80 wt %, from 25 wt % to 75 wt %, from 30 wt % to 70 wt %, from 35 wt % to 65 wt %, or from 40 wt % to 50 wt %. Accordingly, in such embodiments, the polyethylene-based composition comprises the second polyethylene-based component in amounts from 15 wt % to 85 wt % of polyethylene-based composition, such as from 20 wt % to 80 wt %, from 25 wt % to 75 wt %, from 30 wt % to 70 wt %, from 35 wt % to 65 wt %, or from 40 wt % to 50 wt %.

In embodiments where the polyethylene-based composition comprises a blend of the third polyethylene-based component and the second polyethylene-based component, the polyethylene-based composition comprises the third polyethylene-based component in amounts from 15 wt % to 85 wt % of polyethylene-based composition, such as from 20 wt % to 80 wt %, from 25 wt % to 75 wt %, from 30 wt % to 70 wt %, from 35 wt % to 65 wt %, or from 40 wt % to 50 wt %. Accordingly, in such embodiments, the polyethylene-based composition comprises the second polyethylene-based component in amounts from 15 wt % to 85 wt % of polyethylene-based composition, such as from 20 wt % to 80 wt %, from 25 wt % to 75 wt %, from 30 wt % to 70 wt %, from 35 wt % to 65 wt %, or from 40 wt % to 50 wt %.

Accordingly, in embodiments, the polyethylene-based composition comprises the second polyethylene-based component in amounts from 15 wt % to 85 wt % of polyethylene-based composition, such as from 20 wt % to 80 wt %, from 25 wt % to 75 wt %, from 30 wt % to 70 wt %, from 35 wt % to 65 wt %, or from 40 wt % to 50 wt %.

In embodiments, the polyethylene-based composition may be: a blend of the first polyethylene-based component and the second polyethylene-based component; a blend of the second polyethylene-based component and the third polyethylene-based component; or a blend of the first polyethylene-based component, the second polyethylene-based component, and the third polyethylene-based component.

It should be understood that in embodiments, the core layer may comprise, consist essentially of, or consist of the polyethylene-based composition disclosed and described hereinabove. In other embodiments, the core layer may be a blend comprising, consisting essentially of, or consisting of the polyethylene-based composition disclosed and described hereinabove and any number of additional polyethylene-based compositions. The number of polyethylene-based compositions used in combination in the core layer is not limited and may include two, three, four, or more polyethylene-based compositions according to embodiments.

### Manufacture of the First Polyethylene-Based Component

For those embodiments where the core layer comprises the first polyethylene-based component as described herein, the following description provides information regarding polymerization and potential catalysts. Additional information regarding manufacture of the first polyethylene-based component may be found in the Examples section below.

### Polymerization

In embodiments, the first polyethylene-based component may be made by a solution phase polymerization process. In general, the solution phase polymerization process occurs in one or more well-mixed reactors such as one or more isothermal loop reactors or one or more adiabatic reactors at a temperature in the range of from 115° C. to 250° C.; for example, from 115° C. to 200° C., and at pressures in the range of from 300 psi to 1,000 psi; for example, from 400 psi to 750 psi. In some embodiments, in a dual reactor, the temperature in the first reactor is in the range of from 115° C. to 190° C., for example, from 115° C. to 175° C., and the second reactor temperature is in the range of 150° C. to 250° C., for example, from 130° C. to 165° C. In other embodiments, in a single reactor, the temperature in the reactor is in the range of from 115° C. to 250° C., for example, from 115° C. to 225° C.

The residence time in solution phase polymerization process may be in the range of from 2 to 30 minutes; for example, from 10 to 20 minutes. Ethylene, solvent, hydrogen, one or more catalyst systems, optionally one or more cocatalysts, and optionally one or more comonomers are fed continuously to one or more reactors. Exemplary solvents include, but are not limited to, isoparaffins. For example, such solvents are commercially available under the name ISOPAR E from ExxonMobil Chemical Co., Houston, Texas. The resultant mixture of the polyethylene component and solvent is then removed from the reactor and the polyethylene component is isolated. Solvent is typically recovered via a solvent recovery unit, i.e. heat exchangers and vapor liquid separator drum, and is then recycled back into the polymerization system.

In one embodiment, the polyethylene component may be produced via solution polymerization in a dual reactor system, for example a dual loop reactor system, wherein ethylene is polymerized in the presence of one or more catalyst systems. In some embodiments, only ethylene is polymerized. Additionally, one or more cocatalysts may be present. In another embodiment, the polyethylene component may be produced via solution polymerization in a single reactor system, for example a single loop reactor system, wherein ethylene is polymerized in the presence of two catalyst systems. In some embodiments, only ethylene is polymerized.

### Catalyst Systems

Specific embodiments of catalyst systems that can be used to produce the polyethylene compositions described herein will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” is used herein to indicate that the R groups, such as, R¹, R², R³, R⁴, and R⁵ can be identical or different (e.g., R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. These definitions are intended to supplement and illustrate, not preclude, the definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₄₀)alkyl is an alkyl group having from 1 to 40 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₄₀)alkyl substituted with exactly one group R^{S}, where R^{S} is phenyl (—C₆H₅)” may contain from 7 to 46 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or function group is replaced by a substituent (e.g. R⁵). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified mean the same thing.

The term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, in which each hydrocarbon radical and each hydrocarbon diradical is aromatic or non-aromatic, saturated or unsaturated, straight chain or branched chain, cyclic (including mono-and poly-cyclic, fused and non-fused polycyclic, including bicyclic; 3 carbon atoms or more) or acyclic and is unsubstituted or substituted by one or more R^{S}.

In this disclosure, a (C₁-C₄₀)hydrocarbyl can be an unsubstituted or substituted (C₁-C₄₀)alkyl, (C₃-C₄₀)cycloalkyl, (C₁-C₂₀)cycloalkyl-(C₁-C₂₀)alkylene, (C₆-C₄₀)aryl, or (C₆-C₂₀)aryl-(C₁-C₂₀)alkylene. In some embodiments, each of the aforementioned (C₁-C₄₀)hydrocarbyl groups has a maximum of 20 carbon atoms (i.e, (C₁-C₂₀)hydrocarbyl) and other embodiments, a maximum of 12 carbon atoms.

The terms “(C₁-C₄₀)alkyl” and “(C₁-C₁₈)alkyl” mean a saturated straight or branched hydrocarbon radical of from 1 to 40 carbon atoms or from 1 to 18 carbon atoms, respectively, that is unsubstituted or substituted by one or more R^{S}. Examples of unsubstituted (C₁-C₄₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2- methylpropyl; 1,1-dimethylethyl; 1-pentyl; 1-hexyl; 1-heptyl; 1-nonyl; and 1-decyl. Examples of substituted (C₁-C₄₀)alkylare substituted (C₁-C₂₀)alkyl, substituted (C₁-C₁₀)alkyl, trifluoromethyl, and [C₄₅]alkyl. The term “[C₄₅]alkyl” (with square brackets) means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₄₀)aryl” means an unsubstituted or substituted (by one or more R^{S}) mono-, bi-or tricyclic aromatic hydrocarbon radical of from 6 to 40 carbon atoms, of which at least from 6 to 14 of the carbon atoms are aromatic ring carbon atoms, and the mono-, bi- or tricyclic radical comprises 1, 2, or 3 rings, respectively; wherein the 1 ring is aromatic and the 2 or 3 rings independently are fused or non-fused and at least one of the 2 or 3 rings is aromatic. Examples of unsubstituted (C₆-C₄₀)aryl are unsubstituted (C₆-C₂₀)aryl unsubstituted (C₆-C₁₈)aryl; 2-(C₁-C₅)alkyl-phenyl; 2,4-bis (C₁-C₅)alkyl-phenyl; phenyl; fluorenyl;tetrahydrofluorenyl; indacenyl; hexahydroindacenyl; indenyl; dihydroindenyl; naphthyl; tetrahydronaphtbyl; and phenanthrene. Examples of substituted (C₆-C₄₀)aryl are substituted (C₁-C₂₀)aryl; substituted (C₆-C₁₈)aryl; 2,4-bis [(C₂₀)alkyl]-phenyl; polyfluorophenyl; pentafluorophenyl; and fluoren-9-one-1-yl.

The term “(C₃-C₄₀)cycloalkyl” means a saturated cyclic hydrocarbon radical of from 3 to 40 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl,cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl,cyclopentanon-2-yl, and 1-fluorocyclohexyl.

Examples of (C₁-C₄₀)hydrocarbylene include unsubstituted or substituted (C₆-C₄₀)arylene, (C₃-C₄₀)cycloalkylene, and (C₁-C₄₀)alkylene (e.g., (C₁-C₂₀)alkylene). In some embodiments, the diradicals are on the same carbon atom (e.g., —CH₂—) or on adjacent carbon atoms (i.e., 1,2-diradicals), or are spaced apart by one, two, or more than two intervening carbon atoms (e.g., respective 1,3-diradicals, 1,4-diradicals, etc.). Some diradicals include a,w-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e.—CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₄₀)alkylene” means a saturated straight chain or branched chain diradical (i.e., the radicals are not on ring atoms) of from 1 to 40 carbon atoms that isunsubstituted or substituted by one or more R^{S}. Examples of unsubstituted (C₁-C₅₀)alkyleneare unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and-(CH₂)₁₄C(CH₃)₂(CH₂)₅-(i.e., a 6,6-dimethyl substituted normal-1,20-eicosylene). Since as mentioned previously two R⁵ may be taken together to form a (C₁-C₁₈)alkylene, examples of substituted (C₁-C₅₀)alkylenealso include 1,2-bis(methylene)cyclopentane, 1,2-bis(methylene)cyclohexane, 2,3-bis(methylene)-7,7-dimethyl-bicyclo[2.2.1]heptane, and 2,3-bis(methylene)bicyclo[2.2.2]octane.

The term “(C₃- C₄₀)cycloalkylene” means a cyclic diradical (i.e., the radicals are on ring atoms) of from 3 to 40 carbon atoms that is unsubstituted or substituted by one or more R^{S}.

The term “heteroatom,” refers to an atom other than hydrogen or carbon. Examples of heteroatoms include O, S, S(O), S(O)₂, Si(R^{C})₂, P(R^{P}), N(R^{N}), —N═C(R^{C})₂, —Ge(R^{C})₂—, or —Si(R^{C})—, where each R^{C}, each R^{A}, and each R^{P} is unsubstituted (C₁-C₁₈)hydrocarbyl or —H. The term “heterohydrocarbon” refers to a molecule or molecular framework in which one or more carbon atoms are replaced with a heteroatom. The term “(C₁-C₄₀)heterohydrocarbyl” means a heterohydrocarbon radical of from 1 to40 carbon atoms and the term “(C₁-C₄₀)heterohydrocarbylene” means a heterohydrocarbon diradical of from 1 to 40 carbon atoms, and each heterohydrocarbon has one or more heteroatoms. The radical of the heterohydrocarbyl is on a carbon atom or a heteroatom, and diradicals of the heterohydrocarbyl may be on: (1) one or two carbon atom, (2) one or two heteroatoms, or (3) a carbon atom and a heteroatom. Each (C₁-C₅₀)heterohydrocarbyl and (C₁-C₅₀)heterohydrocarbylenemay be unsubstituted or substituted (by one or more R^{S}), aromatic or non-aromatic, saturated or unsaturated, straight chain or branched chain, cyclic (including mono-and poly-cyclic, fused and non-fused polycyclic), or acyclic.

The (C₁-C₄₀)heterohydrocarbyl may be unsubstituted or substituted (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄)hydrocarbyl-Si(R^{C})₂—, (C₁-C₄₀)hydrocarbyl-N(R^{N}), (C₁-C₄₀)hydrocarbyl-P(R^{P}), (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl- (C₁-C₂₀)heteroalkylene, (C₁-C₄₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₄-C₄₀)heteroaryl” means an unsubstituted or substituted (by one or more R^{S}) mono-, bi-or tricyclic heteroaromatic hydrocarbon radical of from 4 to 40 total carbon atoms and from 1 to 10 heteroatoms, and the mono-, bi-or tricyclic radical comprises 1, 2 or 3 rings, respectively, wherein the 2 or 3 rings independently are fused or non-fused and at least one of the 2 or 3 rings is heteroaromatic. Other heteroaryl groups (e.g., (Cₓ-C_{y})heteroaryl generally, such as (C₄-C₁₂)heteroaryl) are defined in an analogous manner as having from x to y carbon atoms (such as 4 to 12 carbon atoms) and being unsubstituted or substituted by one or more than one R⁵. The monocyclic heteroaromatic hydrocarbon radical is a 5-membered or 6-membered ring The 5-membered ring has 5 minus h carbon atoms, wherein h is the number of heteroatoms and may be 1, 2, or 3; and each heteroatom may be O, S, N, or P. Examples of S-membered ring beteroaromatic hydrocarbon radical are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radical are pyridine-2-yl; pyrimidin-2-yl; and pyrazin-2-yl. The bicyclic heteroaromatic hydrocarbon radical can be a fused 5,6-or 6,6-ring system. Examples of the fused 5,6-ring system bicyclic heteroaromatic hydrocarbon radical are indol-1-yl; and benzimidazole-1-yl Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo [3,2-f] indol-1-yl. An example of the fused 5,6,6-ring system is 1H-benzo [f]indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The aforementioned heteroalkyl may be saturated straight or branched chain radicals containing (C₁-C₅₀) carbon atoms, or fewer carbon atoms and one or more of the heteroatoms. Likewise, the heteroalkylene may be saturated straight or branched chain diradicals containing from 1 to 50 carbon atoms and one or more than one heteroatoms. The heteroatoms, as defined above, may include Si(R^{C})₃, Ge(R^{C})₃, Si(R^{C})₂, Ge(R^{C})₂, P(R^{P})₂, P(R^{P}), N(R^{N})₂, N(R^{N}), N, O, ORC, S, SRC, S(O), and S(O)₂, wherein each of the heteroalkyl and heteroalkylene groups are unsubstituted or substituted by one or more R^{S}.

Examples of unsubstituted (C₂-C₄₀)heterocycloalkyl are unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (C₁), bromine atom (Br), or iodine atom (I). The term “halide” means anionic form of the halogen atom: fluoride (F⁻), chloride (Cl⁻), bromide (Br⁻), or iodide (I⁻). The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, and (in heteroatom-containing groups) carbon-nitrogen, carbon-phosphorous, and carbon-silicon double bonds, not including any such double bonds that may be present in substituents R^{S}, if any, or in (hetero) aromatic rings, if any.

According to some embodiments, a catalyst system for producing a polyethylene composition includes a metal-ligand complex according to formula (I):

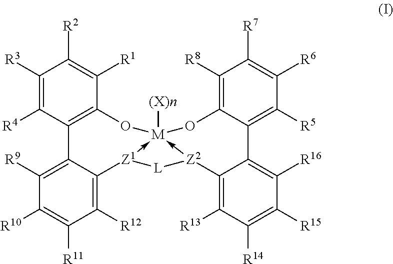

In formula (I), M is a metal chosen from titanium, zirconium, or hafnium, the metal being in a formal oxidation state of +2, +3, or +4; n is 0, 1, or 2; when n is 1, X is a monodentate ligand or a bidentate ligand; when n is 2, each X is a monodentate ligand and is the same or different; the metal-ligand complex is overall charge-neutral; each Z is independently chosen from −O—, —S—, —N(R^{N})—, or —P(R^{P})—; L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)₂, Si(R^{C})₂, Ge(R^{C})₂, P(R^{C}), or N(R^{C}), wherein independently each Re is (C₁-C₃₀)hydrocarbyl or (C₁-C₃₀)heterohydrocarbyl; R¹ and R⁸ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —ORC₁-SRC₁-NO_{2,}—CN, —CF3, R^{C}S(O)—, R^{C}S(0)₂—,(R^{C})₂C=N—, R^{C}OC(O) O—, R^{C}OC (O)—, R^{C}C(O) N(R^{N})—, (R^{N})₂NC(O)—, halogen, and radicals having formula (II), formula (III), or formula (IV):

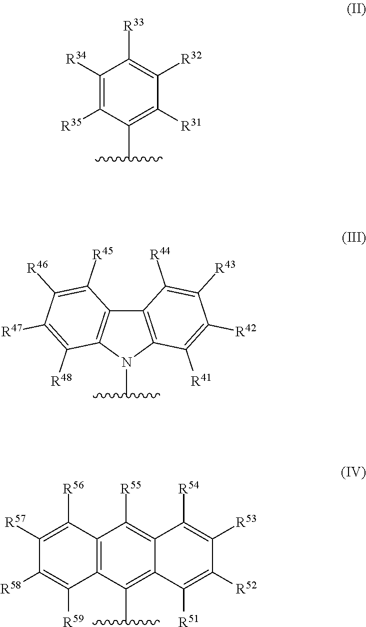

In formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})_{2,}-N(R^{N})₂, —N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O) N(R^{N})—,(R^{N})₂NC (O)—, halogen, or —H, provided at least one of R¹ or R⁸ is a radical having formula (II), formula (III), or formula (IV).

In formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N-CHRC₁-ORC₁-SRC₁-NO2, —CN, —CF3, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, halogen, and —H.

In some embodiments, the polyethylene composition is formed using a first catalyst according to formula (I) in a first reactor and a different catalyst according to formula (I) in a second reactor.

In one exemplary embodiment where a dual loop reactor is used, the procatalyst used in the first loop is zirconium, [[2,2′″-[bis [1-methylethyl)germylene]bis(methyleneoxy-KO)] bis [3″,5,5″-tris(1,1-dimethylethyl)-5′-octyl[1,1′:3′,1″-terphenyl]-2′-olato-κO]](2-)] dimethyl-, having the chemical formula C₈₆H₁₂₈F₂GeO₄Zr and the following structure:

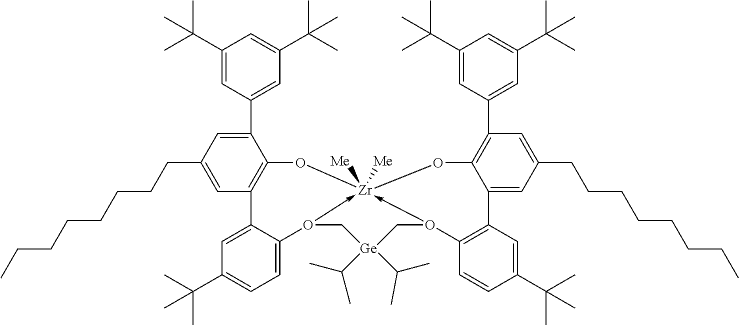

In such an embodiment, the procatalyst used in the second loop is zirconium, [[2,2′″-[1,3-propanediylbis(oxy-κO)]bis[3-[2,7-bis(1,1-dimethylethyl)-9H-carbazol-9-yl]]-5′-(dimethyloctylsilyl)-3′-methyl-5-(1,1,3,3-tetramethylbutyl) [1,1]-biphenyl]-2-olato-κO]](2-)]dimethyl, having the chemical formula C₁₀₇H₁₅₄N₂O₄Si₂Zr and the following structure:

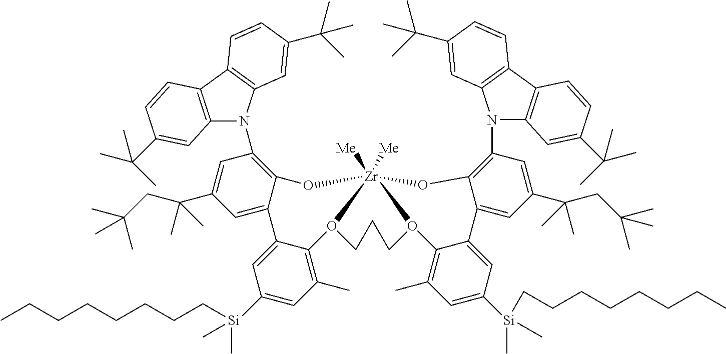

### Co-Catalyst Component

The catalyst system comprising a metal-ligand complex of formula (I) may be rendered catalytically active by any technique known in the art for activating metal-based catalysts of olefin polymerization reactions. For example, the system comprising a metal-ligand complex of formula (I) may be rendered catalytically active by contacting the complex to, or combining the complex with, an activating co-catalyst. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activators (co-catalysts) include Group 13 metal compounds containing from 1 to 3 (C₁-C₂₀)hydrocarbyl substituents as described herein. In one embodiment,

Group 13 metal compounds are tri ((C₁-C₂₀)hydrocarbyl)-substituted-aluminum or tri((C₁-C₂₀)hydrocarbyl)-boron compounds. In other embodiments, Group 13 metal compounds are tri(hydrocarbyl)-substituted-aluminum, tri((C₁-C₂₀)hydrocarbyl)-boron compounds, tri((C₁-C₁₀)alkyl) aluminum, tri((C₆-C₁₈)aryl) boron compounds, and halogenated (including perhalogenated) derivatives thereof. In further embodiments, Group 13 metal compounds are tris(fluoro-substituted phenyl)boranes, tris(pentafluorophenyl) borane. In some embodiments, the activating co-catalyst is a tris((C₁-C₂₀)hydrocarbyl borate (e.g. trityl tetrafluoroborate) or a tri((C₁-C₂₀)hydrocarbyl) ammonium tetra((C₁-C₂₀)hydrocarbyl)borane (e.g. bis (octadecyl) methylammonium tetrakis (pentafluorophenyl) borane). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different

Combinations of neutral Lewis acid activators (co-catalysts) include mixtures comprising a combination of a tri((C₁-C₄)alkyl) aluminum and a halogenated tri((C₆-C₁₈)aryl) boron compound, especially a tris(pentafluorophenyl) borane. Other embodiments are combinations of such neutral Lewis acid mixtures with a polymeric or oligomeric alumoxane, and combinations of a single neutral Lewis acid, especially tris(pentafluorophenyl) borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:30, in other embodiments, from 1:1:1.5 to 1:5:10.

The catalyst system comprising the metal-ligand complex of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis (hydrogenated tallow alkyl) methyl, tetrakis (pentafluorophenyl) borate (1) amine, and combinations thereof.

In some embodiments, one or more of the foregoing activating co-catalysts are used in combination with each other. An especially preferred combination is a mixture of a tri((C₁-C₄)hydrocarbyl) aluminum, tri((C₁-C₄)hydrocarbyl) borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some other embodiments, at least 1:1000; and 10:1 or less, and in some other embodiments, 1.1 or less. When an alumoxane alone is used as the activating co-catalyst, preferably the number of moles of the alumoxane that are employed is at least 100 times the number of moles of the metal-ligand complex of formula (I). When tris(pentafluorophenyl) borane alone is used as the activating co-catalyst, in some other embodiments, the number of moles of the tris(pentafluorophenyl) borane that are employed to the total number of moles of one or more metal-ligand complexes of formula (1) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (1).

### Biaxially Oriented Multilayer Films

The biaxially oriented polyethylene films of the present disclosure are multilayer films. As previously indicated, such films include a core layer comprising the polyethylene-based composition described herein.

The amount of the polyethylene-based composition used in the core layer of embodiments can depend on a number of factors including, for example, the other layers in the film, the desired properties of the film, the end use application of the film, and others. As disclosed above, in embodiments, the core layer consists or consists essentially of the polyethylene-based composition. In embodiments where the core layer comprises a blend of compositions, the core layer comprises the polyethylene-based composition disclosed and described herein in amounts from 30 weight percent (wt %) to 70 wt % of the core layer, such as from 35 wt % to 70 wt %, from 40 wt % to 70 wt %, from 45 wt % to 70 wt %, from 50 wt % to 70 wt %, from 55 wt % to 70 wt %, from 60 wt % to 70 wt %, from 65 wt % to 70 wt %, from 30 wt % to 65 wt %, from 35 wt % to 65 wt %, from 40 wt % to 65 wt %, from 45 wt % to 65 wt %, from 50 wt % to 65 wt %, from 55 wt % to 65 wt %, from 60 wt % to 65 wt %, from 30 wt % to 60 wt %, from 35 wt % to 60 wt %, from 40 wt % to 60 wt %, from 45 wt % to 60 wt %, from 50 wt % to 60 wt %, from 55 wt % to 60 wt %, from 30 wt % to 55 wt %, from 35 wt % to 55 wt %, from 40 wt % to 55 wt %, from 45 wt % to 55 wt %, from 50 wt % to 55 wt %, from 30 wt % to 50 wt %, from 35 wt % to 50 wt %, from 40 wt % to 50 wt %, from 45 wt % to 50 wt %, from 30 wt % to 45 wt %, from 35 wt % to 45 wt %, from 40 wt % to 45 wt %, or from 30 wt % to 35 wt %.

The number of layers in the film can depend on a number of factors including, for example, the desired properties of the film, the desired thickness of the film, the content of the other layers of the film, the end use application of the film, the equipment available to manufacture the film, and others. For example, a multilayer film can further comprise other layers typically included in multilayer films depending on the application including, for example, sealant layers, barrier layers, tie layers, structural layers, etc. A multilayer blown or cast film can comprise up to 2, 3, 4, 5, 6, 7, 8, 9, 10, or 11 layers in various embodiments.

Layers other than the core, also referred to herein as skin layers, within a multilayer film of embodiments of the present disclosure can comprise a propylene-based polymer. In embodiments, the propylene-based polymer may be a co-polymer with propylene and other olefins such as ethylene, butane, and the like. The Propylene-based polymer can, according to embodiments, also be ter-polymer with propylene and other olefins such as ethylene, butane, and the like.

In embodiments, one or more skin layers comprises a propylene-based composition. Using a propylene-based composition as in the skin layers in combination with the core layer as described hereinabove allows the biaxially oriented multilayer film to be used in traditional propylene processing lines because they have stiffness and melting properties similar to propylene-based films. However, the biaxially oriented multilayer films of embodiments disclosed herein may be more readily recycled than films comprising significantly more propylene. Moreover, too much propylene in a film can cause issues of the haze and clarity of a multilayer film. In embodiments, the skin layer may comprise, consist, or consist essentially of a propylene-based composition having a DSC Tm that is from 120° C. to 150° C., such as from 120° C. to 150° C., from 130° C. to 150° C., from 140° C. to 150° C., from 100° C. to 140° C., from 120° C. to 140° C., from 130° C. to 140° C., from 100° C. to 130° C., from 120° C. to 130° C., or from 100° C. to 120° C. In embodiments, the propylene-based composition can be Sanren F800E manufactured by Sinopec.

The skin layers may, in embodiments, be a blend of a propylene-based composition and another composition, such as an ethylene-based composition, a polymethyl methacrylate (PMMA), polystyrene, or the like. In embodiments where the skin layer is a blend of a propylene-based composition and another composition, the skin layer comprises propylene-based compositions in amounts greater than 40 wt %, such as greater than 45 wt %, greater than 50 wt %, greater than 55 wt %, greater than 60 wt %, greater than 65 wt %, greater than 70 wt %, greater than 75 wt %, greater than 80 wt %, greater than 85 wt %, greater than 90 wt %, or greater than 95 wt %.

The thickness of the biaxially oriented multilayer film according to embodiments is primarily from the core layer. In embodiments, the core layer is greater than 70% of the thickness of the biaxially oriented multilayer film, such as greater than 75% of the thickness of the biaxially oriented multilayer film, greater than 80% of the thickness of the biaxially oriented multilayer film, greater than 85% of the thickness of the biaxially oriented multilayer film, greater than 90% of the thickness of the biaxially oriented multilayer film.

In embodiments, the core layer is greater than 70% and less than 95% of the thickness of the biaxially oriented multilayer film, such as greater than 75% and less than 95% of the thickness of the biaxially oriented multilayer film, greater than 80% and less than 95% of the thickness of the biaxially oriented multilayer film, greater than 85% and less than 95% of the thickness of the biaxially oriented multilayer film, greater than 90% and less than 95% of the thickness of the biaxially oriented multilayer film.

In embodiments, the biaxially oriented multilayer film according to embodiments comprises at least one skin layer. The at least one skin layer comprises less than 30% of the thickness of the biaxially oriented multilayer film, such as less than 25% of the thickness of the biaxially oriented multilayer film, less than 20% of the thickness of the biaxially oriented multilayer film, less than 15% of the thickness of the biaxially oriented multilayer film, less than 10% of the thickness of the biaxially oriented multilayer film, or less than 5% of the thickness of the biaxially oriented multilayer film.

In embodiments, the biaxially oriented multilayer film comprises a core layer comprising the polyethylene-based composition disclosed and described herein and at least one skin layer comprising a propylene-based composition.

In one or more embodiments, the biaxially oriented multilayer film comprise a core layer comprising a polyethylene-based composition and two skin layers each comprising a propylene-based polymer. The polyethylene-based composition, in embodiments, comprises, consists essentially of, or consists of a blend of the first polyethylene-based component and the second polyethylene-based component. In embodiments, the polyethylene-based composition comprises, consists essentially of, or consists of a blend of the first polyethylene-based component, the second polyethylene-based component, and the third polyethylene-based component.

It should be understood that, in some embodiments, any of the layers within the film can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

By being polyethylene-based, the biaxially oriented multilayer films, according to embodiments disclosed herein, can be incorporated into articles that are comprised primarily, if not substantially or entirely, of polyethylene in order to provide a film and articles that is more easily recyclable. For example, a film that comprises primarily polyethylene has an improved recyclability profile in addition to other advantages that the usage of such polymers may provide. For example, in some embodiments, other than additives, the multilayer film is comprised entirely of ethylene-based polymers.

In embodiments, the biaxially oriented multilayer film comprise at least 65 wt % polyethylene-based components, such as at least 70 wt % polyethylene-based components, at least 75 wt % polyethylene-based components, at least 80 wt % polyethylene-based components, at least 85 wt % polyethylene-based components, at least 90 wt % polyethylene-based components, or at least 95 wt % polyethylene-based components.

The multilayer films, prior to orientation, can have a variety of thicknesses depending, for example, on the number of layers, the intended use of the film, and other factors. Such multilayer films, in some embodiments, have a thickness prior to orientation of 250 to 3200 microns (typically, 500-1920 microns).

Prior to orientation, the polyethylene films can be formed using techniques known to those of skill in the art based on the teachings herein. For example, the films can be blown or cast films. For example, in the case of multilayer films, the layers that can be coextruded, such layers can be coextruded as blown films or cast films using techniques known to those of skill in the art and based on the teachings herein.

In some embodiments where the film is biaxially oriented, the polyethylene film is biaxially oriented using a tenter frame sequential biaxial orientation process. Such techniques are generally known to those of skill in the art. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for relaxing and annealing.

In embodiments, the biaxial orientation is conducted sequentially in two different stretch chambers at pre-determined temperatures. The machine direction orientation (MDO) is conducted in the first chamber. Immediately after that, the sample oriented in machine direction is sent to the second chamber for transverse direction orientation (TDO). In the MDO step, the sheet is first heated by hot air with forced convection at desired temperature (TMDO) for 180 seconds, and then stretched to 5 times in machine direction with 500 percent per second (%/s) of stretch rate. In the TDO step, the sample is heated by circulating air in the second chamber at desired temperature (TTDO) for 30 seconds, prior the 8 times transverse direction orientation with 250%/s of stretch rate.

The proper T_{MDO} for TDO orientation exploring is identified by screening film orientation behavior at various T_{MDO} with 2° C. interval of a fixed T_{TDO} around 2° C. higher than DSC Tm of the core layer. The proper T_{MDO} is defined as the lowest MDO temperature where stable sequential stretch can be achieved. For example, the T_{MDO} of a structure with core layer having around 131° C. DSC Tm is screened by sequential biorientation under various T_{MDO} combining with a fixed T_{TDO} at 133° C. The lowest T_{MDO} that can deliver stable sequential biorientation is the proper T_{MDO} to explore TDO operation window.

In embodiments, the biaxially oriented multilayer film has TDO operation window that is greater than 5° C., greater than 7° C., greater than 10° C., greater than 12° C., greater than 14° C., or greater than 15° C. In one or more embodiments, the biaxially oriented multilayer film has TDO operation window that is from 5° C. to 20° C., such as from 7° C. to 20° C., from 10° C. to 20° C., from 12° C. to 20° C., from 14° C. to 20° C., from 15° C. to 20° C., from 17° C. to 20° C., from 5° C. to 17° C., from 7° C. to 17° C., from 10° C. to 17° C., from 12° C. to 17° C., from 14° C. to 17° C., from 15° C. to 17° C., from 5° C. to 15° C., from 7° C. to 15° C., from 10° C. to 15° C., from 12° C. to 15° C., from 14° C. to 15° C., from 5° C. to 14° C., from 7° C. to 14° C., from 10° C. to 14° C., from 12° C. to 14° C., from 5° C. to 12° C., from 7° C. to 12° C., from 10° C. to 12° C., from 5° C. to 10° C., from 7° C. to 10° C., or from 5° C. to 7° C.

After orientation, the biaxially oriented film has a thickness of 5 to 50 microns in some embodiments. In some embodiments, the biaxially oriented film has a thickness of 15 to 40 microns

In embodiments, the biaxially oriented multilayer films have an average machine direction (MD) modulus that is from 500 megapascals (MPa) to 3500 MPa, such as from 600 MPa to 3000 MPa, from 700 MPa to 2500 MPa, from 800 MPa to 2000 MPa, or from 900 MPa to 1500 MPa. In embodiments, the biaxially oriented multilayer films have an average transverse direction (TD) modulus that is from 700 MPa to 4000 MPa, such as from 1000 MPa to 3500 MPa, from 1250 MPa to 3000 MPa, from 1500 MPa to 2500 MPa, or from 1750 MPa to 2000 MPa.

In some embodiments, depending for example on the end use application, the oriented polyethylene film can be corona treated, plasma treated, or printed using techniques known to those of skill in the art. In some embodiments, the oriented multilayer film can be surface coated with aluminum, silicon oxide, aluminum oxide, or other metals known to those having ordinary skill in the art based on the teachings herein.

In embodiments, the BOPE films disclosed and described herein may be laminated with other layers. The lamination may be had by a suitable and known lamination process, such as adhesive lamination or extrusion lamination.

### Articles

Embodiments of the present disclosure also relate to articles, such as packages, formed from or incorporating biaxially oriented multilayer films as disclosed herein.

Examples of such articles can include flexible packages, pouches, stand-up pouches, In some embodiments, oriented, multilayer and pre-made packages or pouches. polyethylene films or laminates of the present invention can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### TEST METHODS

Unless otherwise indicated herein, the following analytical methods are used in describing aspects of the present invention:

### Melt Index

Melt indices I₂ (or I2) and/or I₁₀ (or I10) were measured in accordance to ASTM D-1238 (method B) at 190° C. and at 2.16 kg and 10 kg load, respectively. Their values are reported in g/10 min.

### Density

Density measurements were measured in accordance to ASTM D792.

### DSC Melt Point

DSC melt point (DSC Tₘ) was measured on a TA instruments Q2000 series differential scanning calorimeter with a heating and cooling rate of 10° C./min under the nitrogen atmosphere. Three cycles were conducted. 1st from ambient to 250° C., 2nd from 250° C. to 0° C., and 3rd from 0° C. to 280° C. The endotherm (melting) peak in the 3rd cycle was analyzed using Integrate Peak Signal Horizontal method in the TA universal analysis software to obtain DSC Tm for each sample.

### Gel Permeation Chromatography (GPC)

Molecular weights (Mw, Mz, Mn, etc.) were measured using GPC unless otherwise indicated.

The chromatographic system consisted of a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( R {V}_{Peak Max}}{Peak Width at \frac{1}{2} height} )}^{2} \qquad ( EQ 2 )$$

where RV is the retention volume in milliliters, the peak width is in milliliters, the peak max is the maximum height of the peak, and ½ height is ½ height of the peak maximum.

$$Symmetry = \frac{( Rear Peak R {V}_{one tenth height )} - R {V}_{Peak max} )}{( R {V}_{Peak max} - Front Peak R {V}_{one tenth height} )} \qquad ( EQ 3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, MW_{(GPC)}, and MZ_{(GPC)} were based on GPC results using the internal IR⁵ detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV (FM Sample)) to that of the decane peak within the narrow standards calibration (RV (FM Calibrated)). Any changes in the time of the decane marker peak are then assumed to be related to a linear-shift in flowrate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

$$Flowrate ( effective ) = Flowrate ( nominal ) * ( R V ( F M Calibrated ) / R V ( F M Sample ) ) . \qquad ( EQ 7 )$$

### Branching Measurements

SCB_{logMw4-5} (averaged short chain branch level of log (Mw) in between 4.0 and 5.0) The composition of polymer resins and blends was tested using GPC. The GPC system consists of a 150° C. high temperature chromatograph equipped with a Polymer Char IR-5 infrared detector, a two-angle light scattering detector (Agilent 1260) and a differential viscometer from Polymer Char. Four PL Mixed A columns (7.5×300 mm), commercially available from Agilent, are installed in series before the IR-5 detector in the detector oven. 1,2,4-trichlorobenzene (TCB, HPLC grade) and 2,5-di-tert-butyl-4-methylphenol (BHT) (such as commercially available from Sigma-Aldrich) are obtained. Eight hundred milligrams of BHT are added to four liters of TCB. TCB containing BHT is now referred to as “TCB.” Sample preparation is done with an autosampler at 2 mg/mL under shaking at 160° C. for 3 hours. The injection volume is 200 ml. The temperature of GPC is 150° C. and the flow rate is 1 mL/min. The GPC is calibrated using a series of narrow molecular weight (Mw) polystyrene standards.

Calibration of the GPC column set is performed with 21 narrow molecular weight distribution polystyrene standards with molecular weights ranging from 580 to 9,835,000 and are arranged in six “cocktail” mixtures with at least a decade of separation between individual molecular weights. A fifth order polynomial is used to fit the respective polyethylene-equivalent calibration points. The polystyrene standard peak molecular weights are converted to polyethylene molecular weights.

IR-5 infrared detector is used to measure the composition along with MWD. The composition detector is calibrated using a series of copolymer standards having varying levels of co-monomer. The wt % co-monomer levels of these samples are obtained by C¹³ NMR. For each standard, the composition related signals are collected, labelled as “Measurement”, “Methylene” (CH₂) and “Methyl” (CH₃). The “Measurement” signal is used as concentration signal when performing molecular weight calibration, while the ratio of the “Methyl” and “Methylene” signals are used for the composition calculation. Plots of the wt % co-monomer from NMR versus these ratios for the series of standards are made. A linear regression of the data results in good fits of the data sets. The wt % co-monomer data can be converted to short chain branching in 1000 total carbon (SCB/1000 C).

Mw is the weight average molecular weight. logMw is the logarithm of weight average molecular weight. W_{logMw} is weight fraction of the portion at specific logMw. S_{logMw} is short chain branch per 1000 carbons of the portion at specific logMw. SCB_{logMw4-5} in (SCB/1000 C) is calculated by below equation:

$${SCB}_{logMw 4 \sim 5} = {\int }_{4.}^{5.} {S}_{logMW} \cdot {w}_{logMw} \cdot d log Mw / {\int }_{4.}^{5.} {w}_{logMw} \cdot d log Mw$$

### Biaxial Orientation

Biaxial orientation is conducted sequentially in two different stretch chambers at pre-determined temperatures. Sheet samples are cut into 10×10 cm size along MD and TD directions and loaded onto the stretching frame, with five clips positioned at each of the four sides. The clips are pneumatically driven to clamp the sample edges, and then the stretching frame is transported into the first chamber. The machine direction orientation (MDO) is conducted in the first chamber. Immediately after that, the sample oriented in machine direction is sent to the second chamber for transverse direction orientation (TDO). In the MDO step, the sample sheet is firstly heated by hot air with forced convection at desired temperature (T_{MDO}) for 180 seconds, then stretched to 5 times in machine direction with 500%/s of stretch rate. In the TDO step, the sample is heated by circulating air in the second chamber at desired temperature (T_{TDO}) for 30 seconds, prior the 8 times transverse direction orientation with 250%/s of stretch rate. Stretched film sample was then unloaded from the stretching frame, aged for at least one week before tested for film properties as described below in this section.

The proper T_{MDO} for TDO orientation exploring is identified by screening film orientation behavior at various T_{MDO} with 2° C. interval combining with a fixed T_{TDO} around 2° C. higher than DSC Tm of the respective core layer. The proper T_{MDO} is defined as the lowest MDO temperature where stable sequential stretch can be achieved. For example, the screen of a structure with core layer having around 131° C. DSC Tm is conducted by sequential biorientation under various T_{MDO} with a fixed T_{TDO} at 133° C. The lowest T_{MDO} that can deliver stable sequential biorientation is the proper T_{MDO} to explore TDO orientation window.

### Haze

Haze is measured in accordance with ASTM D1003 using BYK Gardner Haze-gard.

### Clarity

Clarity is measured in accordance with ASTM D1746.

### Tensile Modulus

Tensile modulus (including machine direction (MD) modulus and transverse direction (TD) modulus) is measured in accordance with 2% secant modulus in ASTM

D882.

Some embodiments of the invention will now be described in detail in the following Examples.

### EXAMPLES

### Materials for Examples and Comparative Examples

Materials used to form films of the examples and the comparative examples are listed in below.

The “first polyethylene-based component” is a high density polyethylene according to embodiments disclosed herein having a melt index (I₂) of 1.1 g/10 min and a density of 0.9668 g/cm³ and is used in the core layer of the examples. A method for making the first polyethylene-based component is provided below.

The “second polyethylene-based component” is INNATE™ TF80, a linear low density polyethylene from The Dow Chemical Company having a melt index (I₂) of 1.7 g/10 min and a density of 0.927 g/cm³ and is used in the core layer of the examples.

The “third polyethylene-based component” is CONTINUUM™ DMDE-6620 NT 7, a high density polyethylene from The Dow Chemical Company, having a melt index (I₂)_{0.3} g/10 min and a density of 0.960 g/cm³ and is used in core layer of some examples.

Exceed XP 6026 (“XP6026”) is a linear low density polyethylene from Exxon Mobil, with a melt index (I₂) of 0.2 g/10 min and a density of 0.916 g/cm³ and is used in the core of comparative examples.

Evolue SP 3022 (“SP3022”) is a linear low density polyethylene from Mitsui Chemical, having a melt index (I₂) of 1.7 g/10 min and a density of 0.926 g/cm³ and is used in the core layer of comparative examples.

CONTINUUM™ DMDC-1270 NT 7 (“DMDC-1270”) is a high density polyethylene from The Dow Chemical Company having a melt index (I₂) of 2.5 g/10 min and a density of 0.955 g/cm³ and is used in the core layer of comparative examples.

Exxon HTA 108 (“HTA-108”) is a high density polyethylene from Exxon Mobil, having a melt index (I₂) of 0.7 g/10 min and a density of 0.961 g/cm³ and is used in core layers of comparative examples.

Skin layers of the examples and comparative examples are made from Sanren F800E propylene random copolymer supplied from Sinopec, with a DSC Tm at 142.6° C.

### Method for Making the First Polyehtylene-Based Composition

The first polyethylene-based component used in the Examples is prepared according to the following process and based on the reaction conditions reported in Table 1.

All raw materials (ethylene monomer) and the process solvent (a narrow boiling range high-purity isoparaffinic solvent, Isopar-E) were purified with molecular sieves before introduction into the reaction environment. Hydrogen was supplied pressurized as a high purity grade and was not further purified. The reactor monomer feed stream was pressurized via a mechanical compressor to above reaction pressure. The solvent feed was pressurized via a pump to above reaction pressure. The individual catalyst components were manually batch diluted to specified component concentrations with purified solvent and pressured to above reaction pressure. All reaction feed flows were measured with mass flow meters and independently controlled with computer automated valve control systems.

The continuous solution polymerization reactors consisted of two liquid full, non-adiabatic, isothermal, circulating, loop reactors that mimic continuously stirred tank reactors (CSTRs) with heat removal. Independent control of all fresh solvent, monomer, hydrogen, and catalyst component feeds to each reactor was possible. The total fresh feed streams to each reactor (solvent, monomer, and hydrogen) were temperature controlled by passing the feed stream through a heat exchanger. The total fresh feed to each polymerization reactor was injected into the reactor at two locations per reactor roughly with equal reactor volumes between each injection location. The fresh feed to the first reactor was controlled typically with each injector receiving half of the total fresh feed mass flow. The fresh feed to the second reactor in series was controlled typically to maintain half of the total ethylene mass flow near each injector, and since the non-reacted ethylene from the first reactor entered the second reactor adjacent to the lower pressure fresh feed, this injector usually had less than half of the total fresh feed mass flow to the second reactor.

The catalyst/cocatalyst components for each reactor were injected into the polymerization reactor through specially designed injection stingers. Each catalyst/cocatalyst component was separately injected into the same relative location in the reactor with no contact time prior to the reactor. The primary catalyst component was computer controlled to maintain the individual reactor monomer conversion at the specified target. The cocatalyst components were fed based on calculated specified molar ratios to the primary catalyst component.

The catalyst used in the first reactor was zirconium, [[2,2′″-[bis [1-methylethyl)germylene]bis(methyleneoxy-KO)] bis [3″,5,5″-tris(1,1-dimethylethyl)-5′-octyl[1,1′:3′,1″-terphenyl]-2′-olato-κO]](2-)]dimethyl-, having the chemical formula C₈₆H₁₂₈F₂GeO₄Zr and the following structure (“Catalyst 1”):

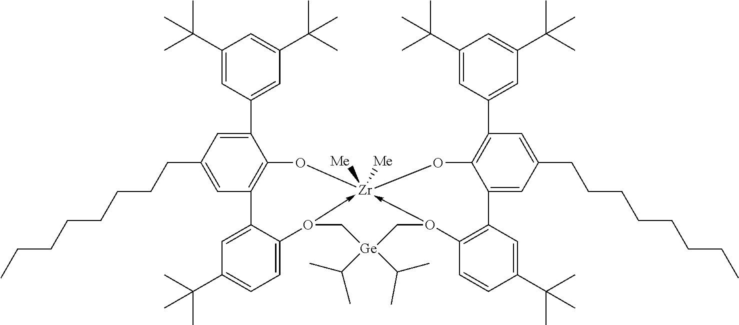

The catalyst used in the second reactor was zirconium, [[2,2′″-[1,3-propanediylbis(oxy-κO)]bis[3-[2,7-bis(1,1-dimethylethyl)-9H-carbazol-9-yl]]-5′-(dimethyloctylsilyl)-3′-methyl-5-(1,1,3,3-tetramethylbutyl [1,1]-biphenyl]-2-olato-κO]](2-)]dimethyl, having the chemical formula C₁₀₇H₁₅₄N₂O₄Si₂Zr and the following structure (“Catalyst 2”):

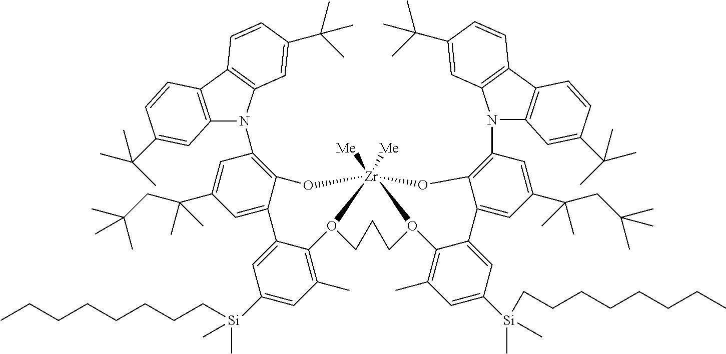

Immediately following each reactor feed injection location, the feed streams were mixed with the circulating polymerization reactor contents with static mixing elements.

The contents of each reactor were continuously circulated through heat exchangers responsible for removing much of the heat of reaction and with the temperature of the coolant side responsible for maintaining an isothermal reaction environment at the specified reactor temperature. Circulation around each reactor loop was provided by a pump.

The effluent from the first polymerization reactor (containing solvent, monomer, hydrogen, catalyst components, and dissolved polymer) exited the first reactor loop and passed through a control valve (responsible for controlling the pressure of the first reactor at a specified target) and was injected into the second polymerization reactor of similar design. The final effluent from the second polymerization reactor entered a zone where it was deactivated with the addition of and reaction with a suitable reagent (water). At this same reactor exit location other additives were added for polymer stabilization. This final effluent stream passed through another set of static mixing elements to facilitate the deactivation of the catalyst and dispersion of the additives.

Following catalyst deactivation and additive addition, the reactor effluent entered a devolatization system where the polymer was removed from the non-polymer stream. The isolated polymer melt was pelletized and collected. The non-polymer stream passed through various pieces of equipment which separated most of the ethylene that was removed from the system. Most of the solvent was recycled back to the reactor after passing through a purification system. A small amount of solvent was purged from the process. The first polyethylene-based component was stabilized with minor (ppm) amounts of stabilizers.

The polymerization conditions for the first polyethylene-based component are reported in Table 1. As seen in Table 1, Cocat. 1 (bis (hydrogenated tallow alkyl) methyl, tetrakis(pentafluorophenyl)borate 1-)amine); and Cocat. 2 (modified methyl aluminoxane (MMAO)) were each used as a cocatalyst for Catalyst 1 and Catalyst 2.

TABLE 1

| | | First |
|---|---|---|
| | | PE-base |
| | | Component |
| First Reactor Feed Solvent/Ethylene | g/g | 6.3 |
| Mass Flow Ratio | | |
| First Reactor Feed Hydrogen/Ethylene | g/g | 1.5E−04 |
| Mass Flow Ratio | | |
| First Reactor Temperature | ° C. | 155 |
| First Reactor Pressure | barg | 50 |
| First Reactor Ethylene Conversion | % | 69.4 |
| First Reactor Catalyst Type | Type | Catalyst 1 |
| First Reactor Co-Catalyst 1 Type | Type | Cocat. 1 |
| First Reactor Co-Catalyst 2 Type | Type | Cocat. 2 |
| First Reactor Co-Catalyst 1 to | Ratio | 1.5 |
| Catalyst Molar Ratio (B to Zr ratio) | | |
| First Reactor Co-Catalyst 2 to | Ratio | 12.5 |
| Catalyst Molar Ratio (Al to Zr ratio) | | |
| Second Reactor Feed Solvent/Ethylene | g/g | 2.6 |
| Mass Flow Ratio | | |
| Second Reactor Feed Hydrogen/Ethylene | g/g | 9.2E−04 |
| Mass Flow Ratio | | |
| Second Reactor Temperature | ° C. | 205 |
| Second Reactor Pressure | barg | 50 |
| Second Reactor Ethylene Conversion | % | 91.1 |
| Second Reactor Catalyst Type | Type | Catalyst 2 |
| Second Reactor Co-Catalyst 1 Type | Type | Cocat. 1 |
| Second Reactor Co-Catalyst 2 Type | Type | Cocat. 2 |
| Second Reactor Co-Catalyst 1 to | mol/mol | 1.8 |
| Catalyst Molar Ratio (B to Zr ratio) | | |
| Second Reactor Co-Catalyst 2 to | mol/mol | 22.9 |
| Catalyst Molar Ratio (Al to Zr ratio) | | |

### Forming the Multilayer Film

A melt blend was conducted to prepare core layer compounds by following the formulation listed in Table 1. The Core layer compounds were fabricated on a Coperion ZSK40 twin screw extruder. The screw speed was 250 rpm and the feed rate was controlled at 50 kg/h. The temperature of different zones was listed in Table 2. All the materials were fed at main feeding port. Vacuum at zone 11 was used in order to remove the volatiles. Under-water pelletizing was used to fabricate pellets. The core layer compounds pellets were then used for characterizations and casted into sheets.

TABLE 1
compound formulation of core layers

| Core ID | Formulation |
|---|---|
| Core-1 | 66 wt % first polyethylene-based component + 34 |
| | wt % second polyethylene-based component |
| Core-2 | 35 wt % first polyethylene-based component + 35 |
| | wt % second polyethylene-based component + 30 |
| | wt % third polyethylene-based component |
| Core-3 | 80 wt % HTA-108 + 20 wt % SP3022 |
| Core-4 | 85 wt % DMDC-1270 + 15 wt % XP6026 |
| Core-5 | 100 wt % second polyethylene-based component |

The second polyethylene-based component is a state-of-art PE used for biaxial orientation, and was used in the Core-1 and Core-2 formulations for orient-ability; the first polyethylene-based component is a HDPE used for high stiffness application, that when blended with the second polyethylene-based component provides Core-1 and Core-2 formulations with desired high density and short chain distribution; the third polyethylene-based component is a very low MI HDPE, which the provides Core-2 formulation with higher molecular weight; HTA-108 is a general HDPE and SP3022 is a comparative PE for biaxial orientation which was disclosed in WO 2019156733 and were combined to make the Core-3 formulation; DMDC-1270 is a high MI HDPE, which allows the Core-4 formulation to have less average short chain branch level in the portion between log (Mw) in 4.0˜5.0, and XP6026 is a low MI LLDPE that provided the Core-4 formulation with a desired density.

TABLE 2
Melt blending temperature settings

| Zone | Temperature (° C.) |
|---|---|
| 1 | Cool |
| 2 | 180 |
| 3 | 200 |
| 4 | 200 |
| 5 | 200 |
| 6 | 200 |
| 7 | 200 |
| 8 | 200 |
| 9 | 200 |
| 10 | 200 |
| 11 | 200 |
| 12 | 200 |
| Adapter | 210 |
| Die | 210 |

Characteristics of the core layer formulations were analyzed by following the test methods introduced in prior section and are listed in Table 3.

TABLE 3
characteristics of core layer compounds

| | Core-1 | Core-2 | Core-3 | Core-4 | Core-5 |
|---|---|---|---|---|---|
| MI (g/10 min) | 1.3 | 0.9 | 0.9 | 1.5 | 1.7 |
| Density (g/cm³) | 0.950 | 0.947 | 0.948 | 0.944 | 0.927 |
| SCB_{logMw4~5} | 5.9 | 5.8 | 3.2 | 3.0 | 10.9 |
| (SCB/1000 C) | | | | | |
| DSC Tm (° C.) | 131.1 | 131.7 | 131.3 | 129.9 | 124.4 |

Six different 3-layer co-extruded sheets were made on a lab scale multilayer cast sheet line supplied by POTOP by following a regular casting sheet process with ˜200° C. of melt temperature. Except for CE-5, which was a monolayer structure, rest of the sheets shared the same skin component and similar total thickness (˜700 μm), but had different core layer components and layer ratios. Detailed structure information is listed in Table 4, where “E” denotes an example according to embodiments, and “CE” denotes a comparative example. The layer ratio is in percentage of thickness.

TABLE 4
multilayer structure examples

| | Layer ratio | Skin layer | Core layer |
|---|---|---|---|
| E-1 | 6%/88%/6% | F800E | Core-1 |
| E-2 | 6%/88%/6% | F800E | Core-2 |
| CE-1 | 6%/88%/6% | F800E | Core-3 |
| CE-2 | 6%/88%/6% | F800E | Core-4 |
| CE-3 | 6%/88%/6% | F800E | Core-5 |
| CE-4 | 20%/60%/20% | F800E | Core-1 |
| CE-5 | Monolayer | Core-1 | Core-1 |

### Biaxial Orientation of the Multilayer Films

Later, biaxial orientation performance of each multilayer coextruded sheet was evaluated on a Karo IV lab stretcher supplied by Brueckner, by following the process described in the prior section. The proper T_{MDO} as defined by the above protocol was found at 129° C. for E-1, E-2, CE-1, and CE-2. For CE-3, the proper T_{MDO} was found as 125° C. Although sharing a same core layer with E-1, orientation of the CE-4 structure was not a success at the best MDO temperature for E-1 (129° C.). CE-4 MDO was operated at 131° C. and combined with a higher TDO temperature to make successful sequential biaxial orientation. Given the layer ratio difference of CE-4, the orientation performance evaluation was conducted at 131° C. MDO temperature, since it is the lowest MDO temperature at which successful orientation can be obtained. MDO of CE-5 was conducted at the proper T_{MDO} of E-1, since they shared the same core layer component. The detailed T_{TDO} window at the best T_{MDO} are summarized in Table 5. In Table 5, three repeating orientation attempts were tried at each MDO/TDO temperature combination to make sure the orientation performance is stable. A successful orientation was defined by good stretches (no film break or slipping off from clips) in all three attempts. Failure is classified once any bad stretch (film break or slipping off from clips) happened.

TABLE 5
Biaxial orientation performance

| | | | | | | | | | Operation | |
|---|---|---|---|---|---|---|---|---|---|---|
| T_{TDO}(° C.) | 120 | 124 | 127 | 130 | 133 | 136 | 140 | 144 | Window | |
| E-1 | F | F | F | S | S | S | F | N | ~6° | C. |
| (T_{MDO}@129° C.) | | | | | | | | | | |
| E-2 | F | F | F | S | S | S | S | S | >14° | C. |
| (T_{MDO}@129° C.) | | | | | | | | | | |
| CE-1 | F | F | F | F | S | F | F | N | ~1° | C. |
| (T_{MDO}@129° C.) | | | | | | | | | | |
| CE-2 | F | F | F | S | S | F | F | N | ~3° | C. |
| (T_{MDO}@129° C.) | | | | | | | | | | |
| CE-3 | F | F | S | S | F | N | N | N | ~3° | C. |
| (T_{MDO}@125° C.) | | | | | | | | | | |
| CE-4 | N | N | N | F | N | F | S | S | >4° | C. |
| (T_{MDO}@131° C.) | | | | | | | | | | |

| | | | | | | | | | |
|---|---|---|---|---|---|---|---|---|---|
| CE-5 | N | F | F | F | F | N | N | N | No window |
| (T_{MDO}@129° C.) | | | | | | | | | |

F: failure, at least one orientation attempt failed
S: success, all orientation attempts succeeded
N: orientation test was not conducted

In the biaxial orientation test, E-1 and E-2 demonstrated significant broader stable operation window comparing to CE-1, CE-2, CE-3, and CE-5.

Typically, film oriented at lower temperature in its orientation window has better optics and higher stiffness. Consequently, film samples made close to the low limitation of orientation window were selected to conduct optical and modulus test by following methods described above. Results are summarized in Table 6. Since CE-5 cannot be successfully oriented at any condition, no film data is available.

TABLE 6
Property summary of biaxially oriented films

| | | | Average | Average |
|---|---|---|---|---|
| | Average | Average | MD | TD |
| | Clarity | Haze | Modulus | Modulus |
| | (%) | (%) | (MPa) | (MPa) |
| E-1 (T_{MDO}@129° C., | 47.3 | 3.2 | 1187.1 | 2075.8 |
| T_{TDO}@130&133° C.) | | | | |
| E-2 (T_{MDO}@129° C., | 60.2 | 3.2 | 1221.1 | 2009.4 |
| T_{TDO}@130&133° C.) | | | | |
| CE-1 (T_{MDO}@129° C., | 27.0 | 3.1 | 1150.5 | 1677.2 |
| T_{TDO}@133° C.) | | | | |
| CE-2 (T_{MDO}@129° C., | 22.6 | 7.3 | 1243.4 | 1333.8 |
| T_{TDO}@130&133° C.) | | | | |
| CE-3 (T_{MDO}@125° C., | 4.3 | 6.5 | 401.9 | 597.8 |
| T_{TDO}@127&130° C.) | | | | |
| CE-4 (T_{MDO}@131° C., | 51.5 | 9.8 | 821.1 | 1283.1 |
| T_{TDO}@140&144° C.) | | | | |

It was found that E-1 and E-2 delivered the best combination of desired optical properties (high clarity and low haze) and high stiffness (high modulus). CE-1 demonstrated good haze and fairly good stiffness, but poor clarity. All of clarity, haze, and TD modulus of CE-2 were inferior to E-1 and E-2. CE-3 delivered both poor optical property and lower stiffness compared to E-1 and E-1. The haze and stiffness of CE-4 are inferior and unfavored compared to E-1 and E-2.

1. A biaxially oriented multilayer film comprising:
a core layer comprising a polyethylene-based composition, the core layer having:
an overall melt index (2) that is from 0.2 g/10 min to 5.0 g/10 min;
an overall density that is between 0.930 g/cm³ and 0.956 g/cm³; and
an average short chain branch level in a portion between log (Mw) of 4.0 to 5.0 (SCB_{logMw4-5}) that is greater than 3.5 SCB/1000 C and less than 10.0 SCB/1000 C; and
at least one additional layer, the at least one additional layer comprising a propylene-based composition.

2. The biaxially oriented multilayer film of claim 1, wherein the propylene-based composition is selected from the group consisting of:
a co-polymer of propylene and other olefins;
a ter-polymer of propylene and other olefins; and
combinations thereof.

3. The biaxially oriented multilayer film of claim 2, wherein the propylene-based composition has a DSC melt point that is from 120° C. to 150° C.

4. The biaxially oriented multilayer film of claim 1, wherein the polyethylene-based composition is a blend comprising a first polyethylene-based component and a second polyethylene-based component.

5. The biaxially oriented multilayer film of claim 4, wherein
the first polyethylene-based component is a high density polyethylene (HDPE) having a melt index (I₂) that is from 01.0 g/10 min to 1.5 g/10 min, and a density that is from 0.965 g/cm³ to 0.970 g/cm³.
the second polyethylene-based component is a linear low density polyethylene (LLDPE) having a melt index (I₂) that is from 0.1 g/10 min to 3.0 g/10 min, and a density that is from 0.915 g/cm³ to 0.930 g/cm³.

6. The biaxially oriented multilayer film of claim 4, wherein, the polyethylene-based composition further comprises a third polyethylene-based component.

7. The biaxially oriented multilayer film of claim 6, wherein the third polyethylene-based component is a high density polyethylene (HDPE) that has a melt index (I₂) that is from 0.1 g/10 min to 0.5 g/10 min, and a density that is from 0.955 g/cm³ to 0.965 g/cm^{3.}

8. The biaxially oriented multilayer film of claim 1, wherein the overall density of the core layer is from 0.940 g/cm³ to 0.955 g/cm³.

9. The biaxially oriented multilayer film of claim 1, wherein the core layer has an average SCBlogMw4-5 that is greater than 4.5 SCB/1000 C.

10. The biaxially oriented multilayer film of claim 1, wherein the biaxially oriented multilayer film was oriented in the machine direction at a draw ratio that is from 4:1 to 7:1; and
oriented in the transverse direction at a draw ratio from 6:1 to 12:1.

11. The biaxially oriented multilayer film of claim 1, wherein the core layer comprises greater than 70% of an overall thickness of the biaxially oriented multilayer film.

12. The biaxially oriented multilayer film of claim 1, wherein the core layer comprises greater than 90% of an overall thickness of the biaxially oriented multilayer film.

13. The biaxially oriented multilayer film of claim 1, wherein the biaxially oriented multilayer film has a machine direction modulus that is from 500 MPa to 3500 MPa, and a transverse direction modulus that is from 700 MPa to 4000 MPa.

14. An article comprising the biaxially oriented multilayer film of claim 1, wherein the article is a flexible package, a pouches, a stand-up pouch, a pre-made packages, or a pre-made pouch.

15. A laminated product comprising the biaxially oriented multilayer film of claim 1.
